(19) United States
(12) Patent Application Publication
(10) Pub. No.: US 2026/0229003 A1
(43) Pub. Date: Aug. 6, 2026

(54) SHEET RECOGNITION UNIT, SHEET HANDLING DEVICE, SHEET RECOGNITION METHOD, AND NON-TRANSITORY COMPUTER-READABLE STORAGE MEDIUM

(71) Applicant: Glory Ltd., Himeji-shi (JP)

(72) Inventor: Toshihiko BANJOYA, Himeji-shi (JP)

(73) Assignee: Glory Ltd., Himeji-shi (JP)

(21) Appl. No.: 19/420,800

(22) Filed: Dec. 16, 2025

(30) Foreign Application Priority Data
Jan. 31, 2025 (JP) 2025-015453

(51) Int. Cl. G06V 10/56; G06V 10/143; G06V 10/60; G06V 20/00; G07D 7/1205; G07D 7/121

(52) U.S. Cl. CPC G06V 10/56; G06V 10/143; G06V 10/60; G06V 20/95; G07D 7/1205; G07D 7/121

(57) ABSTRACT

Provided is a sheet recognition unit that recognizes a sheet on which a photoluminescent ink is printed. The sheet recognition unit includes a light source capable of emitting at least excitation light, a light sensor including a plurality of light receiving elements, a memory that stores a coefficient based on reference data acquired by emitting the excitation light to a reference medium and a feature amount related to the photoluminescent ink associated with the reference data, the coefficient being calculated as a least squares solution with which an error is minimum, and processing circuitry that calculates an estimated value of the feature amount in the sheet to be recognized, using detection data acquired by the light sensor receiving light emitted from the sheet to be recognized, the sheet being irradiated with the excitation light from the light source, and the coefficient.

### CROSS-REFERENCE TO RELATED APPLICATION

The present application claims priority to Japanese Patent Application No. 2025-015453 filed on Jan. 31, 2025 under the Paris Convention and provisions of national law in a designated State. The entire contents of the application are hereby incorporated by reference.

### TECHNICAL FIELD

The present disclosure relates to a sheet recognition unit, a sheet handling device, a sheet recognition method, and a non-transitory computer-readable storage medium.

### BACKGROUND

Conventionally, a photoluminescent compound is known as a security element attached to a sheet such as a banknote. The photoluminescent compound is excited by ultraviolet light to generate fluorescence emission or phosphorescence emission.

### SUMMARY

The sheet recognition unit of the present disclosure is a sheet recognition unit that recognizes a sheet on which a photoluminescent ink is printed, the sheet recognition unit including: a light source capable of emitting at least excitation light; a light sensor including a plurality of light receiving elements; a memory that stores a coefficient based on reference data acquired by emitting the excitation light to a reference medium and a feature amount related to the photoluminescent ink associated with the reference data, the coefficient being calculated as a least squares solution with which an error is minimum; and processing circuitry that calculates an estimated value of the feature amount in a sheet to be recognized, using detection data acquired by the light sensor receiving light emitted from the sheet to be recognized, the sheet being irradiated with the excitation light from the light source, and the coefficient.

### BRIEF DESCRIPTION OF DRAWINGS

FIG. 1 is a schematic diagram illustrating an example of a configuration of a sheet recognition unit according to a first embodiment, and is a diagram viewed from an oblique direction;

FIG. 2 is a schematic perspective view describing an example of a configuration of a light receiving unit included in the sheet recognition unit according to the first embodiment;

FIG. 3 is a schematic diagram illustrating wavelength characteristics of color filters of the light receiving unit included in the sheet recognition unit according to the first embodiment;

FIG. 4 is a schematic diagram illustrating examples of reference data, a coefficient, and a feature amount, and an example of a relationship therebetween in the sheet recognition unit according to the first embodiment;

FIG. 5 is a schematic diagram illustrating an example of calculation processing of an estimated value of the feature amount in the sheet recognition unit according to the first embodiment;

FIG. 6 is a flowchart describing an example of an operation of the sheet recognition unit according to the first embodiment;

FIG. 7 is a diagram illustrating color images of ink samples used in a verification test;

FIG. 8 is a graph showing an evaluation result obtained by the verification test, and showing presence or absence of a pigment in each sample;

FIG. 9 is a schematic perspective view illustrating an appearance of an example of a sheet handling device according to a second embodiment;

FIG. 10 is a schematic cross-sectional view describing an example of a configuration of an imaging unit included in the sheet recognition unit according to the second embodiment;

FIG. 11 is a block diagram describing an example of a configuration of the sheet recognition unit according to the second embodiment;

FIG. 12 is a table showing an example of reference data in the sheet recognition unit according to the second embodiment;

FIG. 13 is a table showing an example of a feature amount (presence or absence of a pigment) in the sheet recognition unit according to the second embodiment;

FIG. 14 is a table showing another example of the feature amount (a content of a pigment) in the sheet recognition unit according to the second embodiment;

FIG. 15 is a table showing still another example of the feature amount (fluorescence peak intensity) in the sheet recognition unit according to the second embodiment;

FIG. 16 is a schematic diagram illustrating examples of reference data, a coefficient, and a feature amount, and an example of a relationship therebetween in the sheet recognition unit according to the second embodiment; and

FIG. 17 is a schematic diagram illustrating an example of calculation processing of an estimated value of the feature amount in the sheet recognition unit according to the second embodiment.

### DETAILED DESCRIPTION

An object of the present disclosure is to provide a sheet recognition unit, a sheet handling device, a sheet recognition method, and a non-transitory computer-readable storage medium capable of discriminating various types of photoluminescent inks and shortening a time required for arithmetic processing for the discrimination.

In order to solve the above problems and achieve the object, (1) a sheet recognition unit from a first aspect of the present disclosure is a sheet recognition unit that recognizes a sheet on which a photoluminescent ink is printed, the sheet recognition unit including: a light source capable of emitting at least excitation light; a light sensor including a plurality of light receiving elements; a memory that stores a coefficient based on reference data acquired by emitting the excitation light to a reference medium and a feature amount related to the photoluminescent ink associated with the reference data, the coefficient being calculated as a least squares solution with which an error is minimum; and processing circuitry that calculates an estimated value of the feature amount in a sheet to be recognized, using detection data acquired by the light sensor receiving light emitted from the sheet to be recognized, the sheet being irradiated with the excitation light from the light source, and the coefficient.

(2) In the sheet recognition unit described in (1), the feature amount may be based on at least one of presence or absence of a pigment, a content of the pigment, or a percentage of the pigment in the photoluminescent ink.

(3) In the sheet recognition unit described in (1), the feature amount may be based on intensity of light emitted from the reference medium irradiated with the excitation light.

(4) In the sheet recognition unit described in any one of (1) to (3), a wavelength of the excitation light emitted from the light source may be shorter than a wavelength of photoluminescence emitted from the sheet to be recognized and received by the light sensor.

(5) In the sheet recognition unit described in any one of (1) to (4), the excitation light emitted from the light source may be ultraviolet light.

(6) In the sheet recognition unit described in any one of (1) to (5), the reference medium may emit light in a plurality of wavelength bands when the excitation light is emitted.

(7) In the sheet recognition unit described in (6), the plurality of wavelength bands may include a visible range and an infrared range.

(8) Further, a sheet handling device from a second aspect of the present disclosure includes the sheet recognition unit described in any one of (1) to (7).

(9) Further, a sheet recognition method from a third aspect of the present disclosure is a sheet recognition method for recognizing a sheet on which a photoluminescent ink is printed, the sheet recognition method including: a first step of emitting at least excitation light to a sheet to be recognized from a light source; a second step of receiving, with a light sensor including a plurality of light receiving elements, light emitted from the sheet to be recognized, the sheet being irradiated with the excitation light; and a third step of calculating an estimated value of a feature amount in the sheet to be recognized, using detection data acquired in the second step and a coefficient based on reference data and the feature amount, the reference data being data acquired by emitting the excitation light to a reference medium, the feature amount relating to the photoluminescent ink associated with the reference data, the coefficient being calculated as a least squares solution with which an error is minimum.

(10) Further, a non-transitory computer-readable storage medium from a fourth aspect of the present disclosure stores a sheet recognition program for recognizing a sheet on which a photoluminescent ink is printed, the sheet recognition program causing a sheet recognition unit to execute: a first processing of emitting at least excitation light to a sheet to be recognized from a light source; a second processing of receiving, with a light sensor including a plurality of light receiving elements, light emitted from the sheet to be recognized, the sheet being irradiated with the excitation light; and a third processing of calculating an estimated value of a feature amount in the sheet to be recognized, using detection data acquired in the second processing and a coefficient based on reference data and the feature amount, the reference data being data acquired by emitting the excitation light to a reference medium, the feature amount relating to the photoluminescent ink associated with the reference data, the coefficient being calculated as a least squares solution with which an error is minimum.

The present disclosure can provide a sheet recognition unit, a sheet handling device, a sheet recognition method, and a non-transitory computer-readable storage medium capable of discriminating various types of photoluminescent inks and shortening a time required for arithmetic processing for the discrimination.

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality.

Processors are considered processing circuitry or circuitry as they include transistors and other circuitry therein. The processor may be a programmed processor which executes a program stored in a memory.

In the disclosure, the circuitry, units, or means are hardware that carry out or are programmed to perform the recited functionality. The hardware may be any hardware disclosed herein or otherwise known which is programmed or configured to carry out the recited functionality.

When the hardware is a processor which may be considered a type of circuitry, the circuitry, means, or units are a combination of hardware and software, the software being used to configure the hardware and/or processor.

Hereinafter, embodiments of a sheet recognition unit, a sheet handling device, a sheet recognition method, and a non-transitory computer-readable storage medium of the present disclosure will be described in detail with reference to the drawings. Various sheets applicable as target sheets of the present disclosure include banknotes, checks, vouchers, bills, forms, securities, and card-like media, but hereinafter, the present disclosure will be described using devices for banknotes as an example.

Further, in this specification, photoluminescence is a concept including fluorescence and phosphorescence, but hereinafter, the present disclosure will be described using fluorescence (photoluminescence that can be detected during irradiation with excitation light) as an example of photoluminescence. That is, in the following description, “photoluminescence”, “photoluminescence detection signal”, “photoluminescent ink”, and “photoluminescent image”, are respectively “fluorescence”, “fluorescence detection signal”, “fluorescent ink”, and “fluorescent image”.

Note that the sheet recognition program may be introduced in advance into the sheet recognition unit and the sheet handling device, or may be provided to an operator with the program being recorded in a computer-readable recording medium or provided via a network.

As described above, the sheet recognition unit and the sheet handling device of the present disclosure may include a storage unit (memory) including a storage device such as a semiconductor memory (random-access memory [RAM] or read-only memory [ROM]) and a hard disk.

In the following description, the same reference signs are appropriately used for the same portions or portions having similar functions between different drawings, and repeated description thereof is appropriately omitted. Further, in the drawings illustrating a structure, XYZ coordinate systems orthogonal to each other are appropriately illustrated.

### First Embodiment

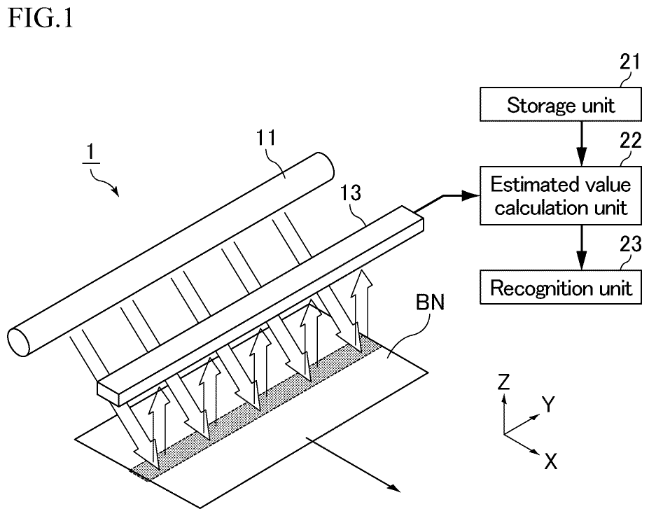

A configuration of the sheet recognition unit according to the present embodiment will be described with reference to FIG. 1.

As illustrated in FIG. 1, the sheet recognition unit 1 according to the present embodiment recognizes a banknote on which a fluorescent ink is printed. The sheet recognition unit 1 includes a light source 11, a light receiving unit (light sensor) 13, a storage unit (memory) 21, and an estimated value calculation unit 22. The light source 11 is capable of emitting at least excitation light to a banknote BN to be recognized. The light receiving unit 13 includes a plurality of light receiving elements (not illustrated in FIG. 1). The sheet recognition unit 1 may further include a recognition unit 23.

Here, the banknote BN to be recognized may be transported in an X direction in an XY plane. A Y direction may correspond to a main scanning direction of the light receiving unit 13, and the X direction may correspond to a sub-scanning direction of the light receiving unit 13.

The light source 11 emits excitation light to the banknote BN to excite the fluorescent ink printed on the banknote BN. The light source 11 may be disposed on the same side as the light receiving unit 13 with respect to the banknote BN.

A wavelength of the excitation light emitted from the light source 11 is not limited, and can be set appropriately to the fluorescent ink. However, the wavelength may be shorter than a wavelength of fluorescence emitted from the banknote BN (the fluorescent ink) and received by the light receiving unit 13. As described above, the fluorescent ink used in the present embodiment may absorb energy of light in a specific wavelength band and emit the energy as light in a longer wavelength band.

More specifically, the excitation light emitted from the light source 11 may be ultraviolet light.

The light source 11 may be longer than the length of the banknote BN in the Y direction, and may irradiate the banknote BN entirely in the Y direction with light linearly extending along the Y direction. In this case, the light source 11 may include a transparent, linear rod-shaped light guide, and light emitting elements (usually, a plurality of light emitting diodes (LEDs), for example) facing at least one of both end surfaces of the light guide. The light source 11 may irradiate the banknote BN with light via the light guide.

The light receiving unit 13 is configured to be able to receive fluorescence emitted from the banknote BN to be recognized (fluorescent ink) during emission of the excitation light. At this time, the light receiving unit 13 can function as a sensor having sensitivity at least in the wavelength band of the fluorescence emitted from the fluorescent ink to be recognized. The light receiving unit 13 may receive the fluorescence emitted from the banknote BN irradiated with the excitation light and output a fluorescence detection signal. Further, the light receiving unit 13 may be a sensor having sensitivity to a wavelength band covering at least a visible range to an infrared range (or a near-infrared range). The light receiving unit 13 can then function as a sensor that outputs an electric signal (which may be a digital signal) corresponding to the amount of incident light (light receiving amount). That is, the fluorescence detection signal is an electric signal that depends on an incident light amount of the fluorescence emitted from the banknote BN during a turn-on period of the excitation light.

The light receiving unit 13 includes the plurality of light receiving elements, and the light receiving elements may receive light, convert the light into an electric signal that depends on an incident light amount, and output the electric signal.

The light receiving unit 13 may be longer than the length of the banknote BN in the Y direction, and may receive light transmitted through, reflected from, or emitted from the banknote BN entirely in the Y direction.

The light receiving unit 13 may output an electric signal depending on the amount of incident light as image data. At this time, the light receiving unit 13 may include a plurality of pixels arranged in a row in the Y direction (main scanning direction). That is, the light receiving unit 13 may output an electric signal depending on the amount of incident light at a plurality of channels corresponding to the plurality of pixels (positions in the Y direction (main scanning direction)). Note that the channels (columns) are numbers sequentially allocated to the light receiving elements (imaging elements) in the Y direction. At this time, the light receiving unit 13 may output, as image data, line data that is data related to the light simultaneously received at each channel. The image data of the entire banknote BN may be output by repeating irradiation with light from the light source 11 and reception of light by the light receiving unit 13 while transporting the banknote BN in the X direction (sub-scanning direction).

As described above, the light source 11 and the light receiving unit 13 may acquire the image of the entire banknote BN by continuously and repeatedly executing imaging of a predetermined cycle as one period.

In this specification, one cycle refers to a control pattern in which the timing of turning on and off the light emitting elements in each wavelength band, signal reading, and the like are set. The fluorescence detection signal may be acquired from an entire sheet by continuously and repeatedly executing the control pattern of one cycle as one period. One cycle may indicate a periodic control pattern related to turning-on, turning-off, and light receiving, the control pattern being set to acquire a reflective image and/or transmissive image of the sheet.

The reflective image is an image based on light emitted from a light source disposed on the same side as the light receiving unit with respect to the sheet and reflected from the sheet. The transmissive image is an image based on light emitted from a light source disposed on an opposite side from the light receiving unit with respect to the sheet and transmitted through the sheet. Therefore, the reflective image and the transmissive image are distinguished from a fluorescent image based on fluorescence emitted from a sheet.

The image data that can be acquired by the light receiving unit 13 includes a plurality of pixels arranged in a matrix pattern in the Y direction (main scanning direction) and the X direction (sub-scanning direction). An address of each pixel is specified by a channel (column) of the light receiving unit 13 corresponding to the position in the Y direction and a line (row) corresponding to the position in the X direction. The line (row) is a number sequentially allocated to the line data sequentially output from the light receiving unit 13.

The light receiving unit 13 may receive light in a plurality of wavelength bands coming from the banknote BN and output an electric signal (fluorescence detection signal) for each of the plurality of wavelength bands. In this case, each pixel may include a plurality of light receiving elements that selectively receive light in different wavelength bands.

Examples of the plurality of wavelength bands in which the light receiving unit 13 can selectively receive light include red (R), green (G), blue (B), and infrared (IR) bands.

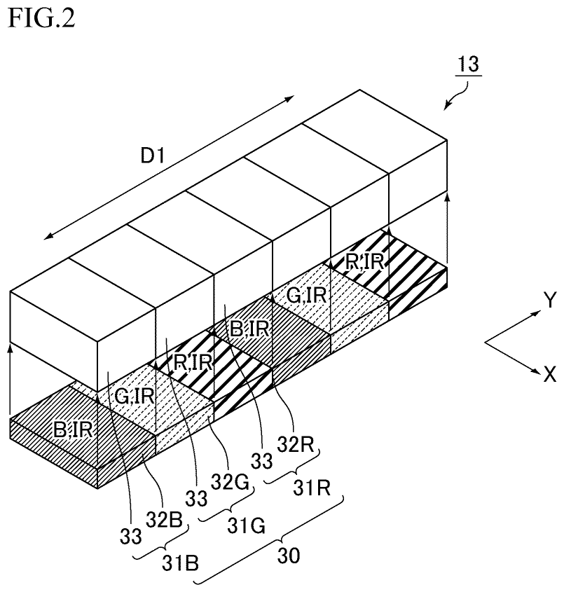

As illustrated in FIG. 2, the light receiving unit 13 may include a first light receiving element 31B having a color filter 32B, a second light receiving element 31G having a color filter 32G, and a third light receiving element 31R having a color filter 32R.

The light receiving unit 13 may include a plurality of pixels 30 arranged in a line in a main scanning direction D1 (direction orthogonal to a transport direction of a banknote BN, i.e. a Y direction). Each pixel 30 may include one first light receiving element (imaging element) 31B, one second light receiving element (imaging element) 31G, and one third light receiving element (imaging element) 31R. The first light receiving element 31B, the second light receiving element 31G, and the third light receiving element 31R may be arranged in a line in this order in the main scanning direction D1.

Here, the light receiving element (imaging element) means an element that detects the intensity of light in a predetermined wavelength band (converts into an electric signal). The light receiving element may include a photodetector such as a photodiode, and a color filter (color resist) that is disposed on a light receiving surface of the photodetector and reduces transmission of light in wavelength bands (for example, green and red wavelength bands) excluding predetermined wavelength bands (for example, blue and infrared wavelength bands) to be detected.

As illustrated in FIG. 2, the first light receiving element 31B may include a photodetector 33 and the color filter 32B, the second light receiving element 31G may include the photodetector 33 and the color filter 32G, and the third light receiving element 31R may include the photodetector 33 and the color filter 32R.

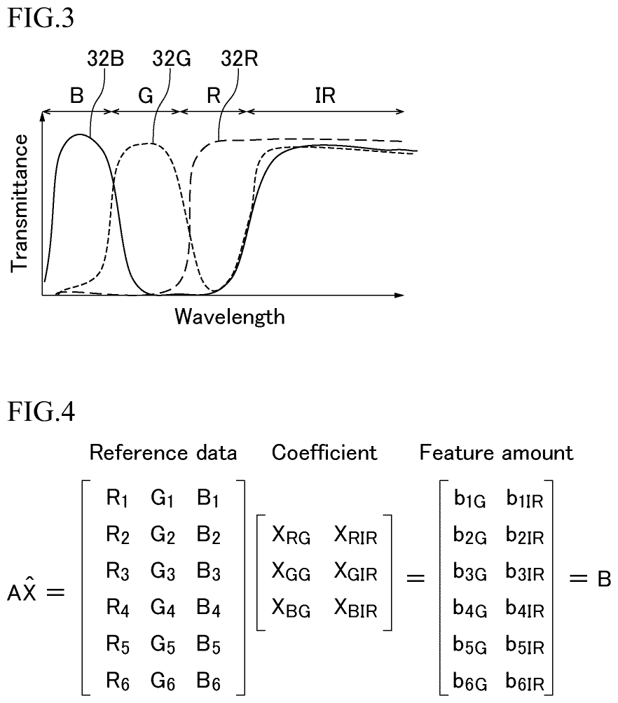

As illustrated in FIG. 3, the color filter 32B transmits blue light and infrared light, the color filter 32G transmits green light and infrared light, and the color filter 32R transmits red light and infrared light. Therefore, the first light receiving element 31B, the second light receiving element 31G, and the third light receiving element 31R receive infrared light together with the corresponding visible light. The color filter 32B absorbs green light and red light, the color filter 32G absorbs blue light and red light, and the color filter 32R absorbs blue light and green light.

The light receiving unit 13 may collectively receive, at each light receiving element, the fluorescent component in the visible range and the fluorescent component in the infrared range emitted from the banknote BN (fluorescent ink) irradiated with the excitation light without separating them. The light receiving unit 13 then may output a fluorescence detection signal including a signal value that depends on a light amount of the sum of both the components.

Even in such a case, the sheet recognition unit 1 can recognize various types of fluorescent inks including fluorescent inks that emit fluorescence in the visible range and the infrared range, respectively.

Specifically, the storage unit 21 stores a coefficient based on reference data acquired by emitting the excitation light to a reference medium and a feature amount relating to the fluorescent ink associated with the reference data. The estimated value calculation unit 22 calculates an estimated value of the feature amount relating to the fluorescent ink of the banknote BN to be recognized, using the detection data acquired by the light receiving unit 13 receiving the light emitted from the banknote BN to be recognized, the banknote being irradiated with the excitation light from the light source 11, and the coefficient. The coefficient is calculated as a least squares solution with which an error is minimum. Use of such a coefficient makes it possible to accurately estimate the feature amounts relating to various fluorescent inks including the fluorescent ink that emits fluorescence in the visible range and the infrared range, based on the detection data of the banknote BN to be recognized even if the light receiving unit 13 cannot separate the fluorescence in the visible range and the infrared range. The various fluorescent inks can be discriminated based on the estimated feature amounts. The arithmetic processing using the coefficient can shorten the time required for the arithmetic processing as compared with the arithmetic processing using the determinant described in JP 7473677 B. As described above, the sheet recognition unit 1 can discriminate various photoluminescent inks, and shorten the time required for the arithmetic processing.

The reference medium is a medium group to be a reference, and includes a plurality of types of fluorescent inks including a genuine fluorescent ink. The plurality of types of fluorescent inks may be the ink itself, or may be a printed material obtained by printing the ink on a base material such as white paper (for example, test sample or banknote).

The plurality of types of fluorescent inks including a genuine fluorescent ink may be configured by only a plurality of types of genuine fluorescent inks, or may include one or more types of genuine fluorescent inks and one or more types of ungenuine inks (for example, counterfeit fluorescent inks).

The genuine fluorescent ink used as the reference medium is compared with the fluorescent ink printed on the banknote BN to be recognized, and emits fluorescence in a predetermined wavelength band during emission of the excitation light (for example, ultraviolet light). The genuine fluorescent ink may include one or more, for example, two or more types of photoluminescent compounds.

Fluorescence characteristics of the reference medium are not limited, but for example, the reference medium (at least one type of the medium group) may emit fluorescence in a plurality of wavelength bands when the excitation light is emitted. The plurality of wavelength bands may include the visible range and the infrared range (which may be the near-infrared range). The reference medium may also include a medium that emits fluorescence in a single wavelength band.

Similarly, the fluorescence characteristics of the genuine fluorescent ink used as the reference medium are not limited. For example, the genuine fluorescent ink may include a fluorescent ink that emits fluorescence in a plurality of wavelength bands, for example, the visible range and the infrared range (or the near-infrared range), or may include a fluorescent ink that emits fluorescence in a single wavelength band. Similarly, the fluorescence spectrum of the genuine fluorescent ink may have a peak in each of the plurality of wavelength bands, for example, the visible range and the infrared range (or the near-infrared range), or may have a peak only in a single wavelength band.

Hereinafter, a reference medium (fluorescent ink) having a peak in each of the visible range and the infrared range may be referred to as a special fluorescent ink.

The special fluorescent ink hardly emits light even when the visible light is emitted, and transmits visible light. Therefore, the special fluorescent ink is not visually recognized by human eyes in a situation where visible light is emitted, for example, under natural light or under general artificial illumination. When the excitation light is emitted to the special fluorescent ink, a fluorescent component that emits light in the visible range can be visually recognized by human eyes. However, even in this case, a fluorescent component that emits light in the infrared range cannot be visually recognized by human eyes. Therefore, the special fluorescent ink can function as a highly secure security element.

For example, ink containing a mixture of a photoluminescent compound that emits fluorescence in the visible range and a photoluminescent compound that emits fluorescence in the infrared range may be printed on a printing portion of the special fluorescent ink. Alternatively, ink containing the photoluminescent compound that emits fluorescence in the visible range and ink containing the photoluminescent compound that emits fluorescence in the infrared range may be applied to be superimposed on the printing portion.

As for the special fluorescent ink, the fluorescence spectrum may have a peak in at least one of a blue wavelength band, a green wavelength band, or a red wavelength band. In the visible range, the fluorescence spectrum may have a peak only in one of the blue wavelength band, the green wavelength band, or the red wavelength band.

As for the special fluorescent ink, the fluorescence spectrum may have a peak in the infrared region, or may have a peak in the near infrared range.

In this specification, blue means light (color) having a wavelength of approximately 400 to 500 nm, and may be light (color) having a peak wavelength in this wavelength band. Green means light (color) having a wavelength of approximately 500 to 600 nm, and may be light (color) having a peak wavelength in this wavelength band. Red means light (color) having a wavelength of approximately 600 to 750 nm, and may be light (color) having a peak wavelength in this wavelength band. The infrared light means light having a wavelength of approximately 750 nm or more, and may be light having a peak wavelength in this wavelength band. The near-infrared light means light having a wavelength of approximately 750 to 1500 nm, and may be light having a peak wavelength in this wavelength band.

The reference data may be RGB values (RGB three-wavelength data) of light emitted from the reference medium irradiated with the excitation light. As the RGB values, one set of RGB values may be used for each reference medium, or a plurality of sets of RGB values may be used for each reference medium. The set of RGB values may be, for example, a representative value (for example, an average value, a median value, etc. for each of the RGB values) of a plurality of sets of RGB values acquired from the reference medium. More specifically, for example, in a case where the reference medium is a test sample in which the fluorescent ink is printed on a base material such as white paper, representative values of RGB values of a plurality of pixels constituting a fluorescent image of the sample may be used as the reference data. Alternatively, the RGB values of the plurality of pixels constituting the fluorescent image of the sample may be used as the reference data.

The reference data may be acquired by the light receiving unit 13. In this case, output values from the third light receiving element 31R, the second light receiving element 31G, and the first light receiving element 31B may be used as the RGB values.

On the other hand, the reference data may be acquired by another means (another device) different from the sheet recognition unit 1.

The feature amount relating to the fluorescent ink indicates the presence or absence, amount, characteristics, etc. of the fluorescent ink, and quantitatively indicates information regarding whether the fluorescent ink is present.

Note that the feature amount related to the fluorescent ink may be acquired by the light receiving unit 13 or may be acquired by another means (another device) different from the sheet recognition unit 1. Further, the feature amount related to the fluorescent ink may be the acquired data itself, or may be data acquired by executing predetermined arithmetic processing on the acquired data.

More specifically, the feature amount related to the fluorescent ink may be based on at least one of the presence or absence of a pigment, the content of the pigment, and the percentage of the pigment in the fluorescent ink, or may be at least one of presence or absence of the pigment, a content of the pigment, or a percentage of the pigment in the fluorescent ink.

The pigment is a component (photoluminescent compound) that characterizes light emission characteristics (for example, an emission color) of the fluorescent ink, and may be a particle.

The content of the pigment is the content of the pigment contained in the fluorescent ink, and may be measured based on, for example, a weight difference between a fluorescent ink containing the pigment and a ink containing no pigment.

The percentage of the pigment is a percentage (for example, percent by weight) of the pigment in the whole fluorescent ink, and may be calculated based on the content of the pigment measured as described above and the weight of the fluorescent ink.

The feature amount related to the fluorescent ink may be based on the intensity of light emitted from the reference medium irradiated with the excitation light, or may be the intensity of light emitted from the reference medium irradiated with the excitation light. The light intensity may be peak intensity of fluorescence emitted from the reference medium.

These intensities may be acquired by another means (another device) different from the sheet recognition unit 1 such as a spectroscopic measurement device. For example, the emission spectrum of the light emitted from the reference medium irradiated with the excitation light may be measured by a spectroscopic measurement device, and the intensity (emission peak value) of the light emitted from the reference medium may be obtained based on the emission spectrum.

The number of the feature amounts (number of variables) related to the fluorescent ink used for the coefficient calculation is not limited and can be appropriately set. However, the number of the feature amounts may be the minimum number required to sort a plurality of types of fluorescent inks (reference medium group), for example, two.

In a case where the reference medium includes the special fluorescent ink, at least a feature amount related to fluorescence emission in the visible range and a feature amount (the same kind of feature amount as the feature amount related to the fluorescence emission in the visible range) related to fluorescence emission in the infrared range (may be the near-infrared range) may be used as the feature amount related to the fluorescent ink used for coefficient calculation.

The coefficient can be calculated, for example, as follows. First, excitation light is emitted to each reference medium to obtain reference data. For example, as illustrated in FIG. 4, output values Rn, Gn, Bn (n is an integer of 1 to 6) from the light receiving unit 13 are acquired (in FIG. 4, a matrix A) when excitation light is emitted to each of six reference media (here, test samples in which six types of fluorescent inks are printed on white paper are assumed). The output values Rn, Gn, and Bn correspond to the output values (RGB values) from the third light receiving element 31R, the second light receiving element 31G, and the first light receiving element 31B, respectively. In addition, each of the output values Rn, Gn, and Bn indicates a representative value (for example, an average value, a median value, etc. for each of the RGB values) of a plurality of output values acquired from target regions of the reference medium.

A feature amount related to the fluorescent ink of each reference medium is then acquired. For example, as illustrated in FIG. 4, as for the six reference media, the values b_{nG} and b_{nIR} (n is an integer of 1 to 6) indicating the presence or absence of a pigment are acquired (in FIG. 4, a matrix B). Here, b_{nG} is a value (for example, 1 or 0) indicating the presence or absence of a pigment having an emission peak in the green wavelength band, and b_{nIR} is a value (for example, 1 or 0) indicating the presence or absence of a pigment having an emission peak in the infrared range. Both b_{nG} and b_{nIR} may be 1 when a pigment is present, and may be 0 when no pigment is present.

Next, the reference data of reference media is associated with the feature amounts related to the fluorescent inks of the reference media. For example, b_{nG}=1 and b_{nIR}=0 are associated with the output values R₂, G₂, and B₂ of the reference medium 2. In this case, the output values R₂, G₂, and B₂ of the reference medium 2 are associated with information indicating that a pigment having an emission peak in the green wavelength band is present and a pigment having an emission peak in the infrared range is not present. In the matrix A and the matrix B illustrated in FIG. 4, elements in the same row are reference data and feature amounts derived from the same reference medium. Thus, the matrix of the reference data and the matrix of the feature amounts related to the fluorescent inks are set so that the reference data of the reference media and the feature amounts related to the fluorescent inks associated with the reference data are in the same row.

Coefficients for estimating the feature amounts are calculated as least squares solutions with which an error is minimum, based on the associated reference data and feature amounts. For example, as illustrated in FIG. 4, least squares solutions of AX=B are calculated as estimated values X\hat{ } of X using a normal equation, and are set as coefficients X_{RG}, X_{GG}, X_{BG}, X_{RIR}, X_{GIR}, and X_{BIR} for estimating the feature amounts (in FIG. 4, a matrix X\hat{ }).

In this specification, not only X\hat{ }but also “\hat{ }” after an alphabetical character represents a hat of the alphabetical character.

Since the example using the representative values is illustrated here, the number of equations is six, but RGB values of the plurality of pixels may be used. In this case, the equation increases.

Further, since the presence or absence of two types of pigments having emission peaks in two wavelength bands is estimated based on the RGB values (three wavelength data of RGB), the size of the coefficients X (X\hat{ }) is 3 rows and 2 columns.

As long as the least squares solution can be obtained, a method for calculating the coefficients is not limited. For example, even in the case of solving with the normal equation, any method such as geometry, algebra, or differentiation may be used.

Specific examples thereof include the following methods 1 to 5.

### 1. Method for Solving Normal Equation

The least squares solution is obtained by solving A^{T}AX=A^{T}B.

When this case is considered in geometry, for example, an error is minimized by searching for a point closest to B in a (super) plane spanned by AX. The closest point can be calculated as projection P=AX\hat{ }. Then, the error is obtained by E=B−AX\hat{ }. Since the error E is orthogonal to each column of A, three equations hold for X\hat{ }. This can be written as A\hat{ }T (B−AX\hat{ })=0. This is transformed into the normal equation A\hat{ }TAX\hat{ }=A\hat{ }TB. This becomes RX\hat{ }=Q\hat{ }TB when QR decomposition (A=QR) is used, and can be solved by backward substitution.

When this case is considered in terms of differentiation, the error desired to be minimized is expressed by

$$E = {‖ AX - B ‖}^{2} \qquad [ Formula 1 ]$$

Since this is a quadratic function, the error is minimized at the point where the derivative is 0 in any direction. Therefore, the following three equations hold. δE/δX=0
When this is solved, a least squares solution is obtained.

### 2. Method Using QR Decomposition

The matrix A is decomposed into an orthogonal matrix Q and an upper triangular matrix R by using QR decomposition. Specifically, when A=QR, the normal equation is replaced with a simple form of RX=Q^{T}B, and the least squares solution is obtained by solving this equation.

### 3. Method Using Singular Value Decomposition (SVD)

This is a method for decomposing the matrix A into three matrices U, Σ, and V^{T}. Specifically, A=UΣV^{T}. With this method, the least squares solution is obtained in a form of X=VE⁻¹U^{T}b.

### 4. Method Using Direct Solution

The normal equation is directly solved using a direct solution such as Gaussian elimination method or LU decomposition.

### 5. Methods Using Iterative Method

The iterative method such as a conjugate gradient method is used. The solution is gradually approximated without performing reverse rotation directly on a matrix.

The estimated value calculation unit 22 may calculate the estimated value of the feature amount related to the fluorescent ink in the banknote BN to be recognized by calculating a product of the detection data acquired from the banknote BN to be recognized and the coefficient. That is, assuming that the detection data is C and the coefficient is X\hat{ }, the estimated value of the feature amount may be calculated by calculating C·X\hat{ }.

The detection data may be output values (RGB values) from the third light receiving element 31R, the second light receiving element 31G, and the first light receiving element 31B when the excitation light is emitted to the banknote BN to be recognized from the light source 11. Each of these output values may be a representative value (for example, an average value, a median value, etc. for each of the RGB values) of a plurality of output values acquired from target regions (a plurality of pixels) of the banknote BN to be recognized. Alternatively, these output values may be a plurality of output values acquired from the target regions (a plurality of pixels) of the banknote BN to be recognized.

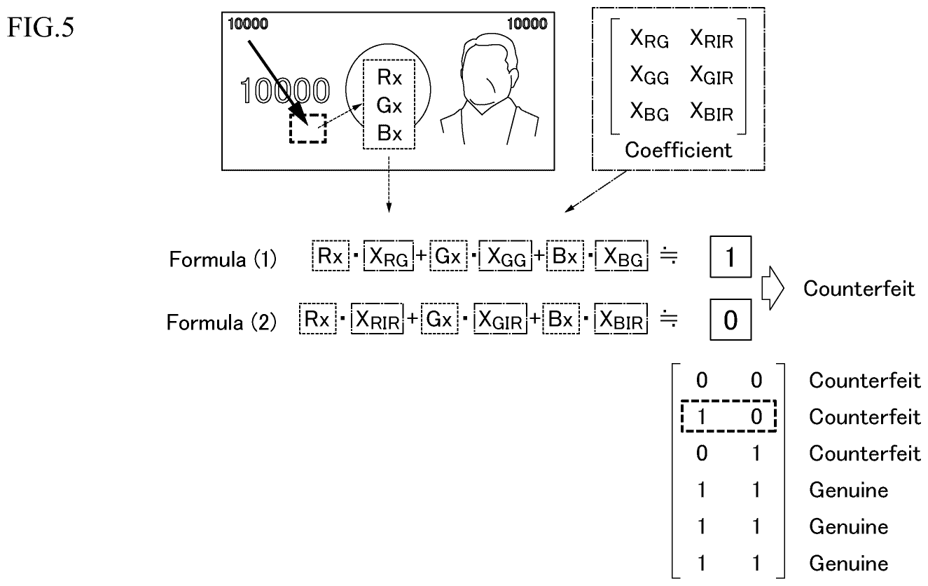

For example, as illustrated in FIG. 5, when the excitation light is emitted to the banknote BN to be recognized, the output values from the light receiving unit 13 are Rₓ, Gₓ, and Bₓ, and coefficients are X_{RG}, X_{GG}, X_{BG}/X_{RIR}, X_{GIR}, and X_{BIR}. The output values Rₓ, Gₓ, and Bₓ correspond to the output values (RGB values) from the third light receiving element 31R, the second light receiving element 31G, and the first light receiving element 31B, respectively. Further, each of the output values Rₓ, Gₓ, and Bₓ indicates a representative value (for example, an average value, a median value, etc. for each of the RGB values) of a plurality of output values acquired from target regions of the banknote BN to be recognized. Then, the estimated value of the feature amount indicating the presence or absence of a pigment having an emission peak in the green wavelength band can be calculated from Formula (1) in FIG. 5. Further, the estimated value of the feature amount indicating the presence or absence of a pigment having an emission peak in the infrared range can be calculated from Formula (2) in FIG. 5. That is, when the calculation results of the Formulas (1) and (2) in FIG. 5 are values close to 1, a determination can be made that both the pigment having the emission peak in the green wavelength band and the pigment having the emission peak in the infrared range exist in the banknote BN to be recognized. When the calculation result of Formula (1) in FIG. 5 is a value close to 1 and the calculation result of Formula (2) in FIG. 5 is a value close to 0, a determination can be made that the pigment having the emission peak in the green wavelength band is present but the pigment having the emission peak in the infrared range is not present in the banknote BN to be recognized. When a reference medium including both a pigment having an emission peak in the green wavelength band and a pigment having an emission peak in the infrared range is a genuine medium, the recognition unit 23 can determine that the banknote BN to be recognized is a genuine note in the former case, and can determine that the banknote BN to be recognized is a counterfeit note in the latter case.

Here, as the feature amount regarding the fluorescent ink, a feature amount regarding a combination of the fluorescence in the green wavelength band and the fluorescence in the infrared range has been described as a specific example. However, for example, a feature amount regarding a combination of fluorescence in the red wavelength band and fluorescence in the infrared range may be used, or a feature amount regarding a combination of fluorescence in the blue wavelength band and fluorescence in the infrared range may be used. More specifically, for example, a combination of a value (for example, 1 or 0) indicating the presence or absence of a pigment having an emission peak in the red wavelength band and a value (for example, 1 or 0) indicating the presence or absence of a pigment having an emission peak in the infrared range may be used as the feature amount regarding the fluorescent ink.

Data in the same format as the reference data is basically used as the detection data. That is, for example, when the reference data is a representative value of a plurality of sets of RGB values acquired from the reference medium, a representative value of a plurality of sets of RGB values acquired from the banknote BN to be recognized is used as the detection data.

Further, the shape of the target region where the detection data is acquired is not limited, and can be set appropriately for a fluorescent ink printing region of the banknote BN to be recognized. The shape may be, for example, rectangular. The target region where the detection data is acquired may be prepared in advance for each type and each orientation of the banknote BN to be recognized. In this case, the recognition unit 23 may first recognize the type and orientation of the banknote BN to be recognized. The estimated value calculation unit 22 may acquire the detection data in the target region appropriate to the type and orientation of the banknote BN to be recognized, based on the recognition result.

The coefficient used for calculating the estimated value of the feature amount may be prepared in advance for each type and each orientation of the banknote BN to be recognized. In this case, the recognition unit 23 may first recognize the type and orientation of the banknote BN to be recognized. The estimated value calculation unit 22 may acquire the coefficient appropriate to the type and orientation of the banknote BN to be recognized, based on the recognition result.

In this specification, the type of a banknote includes a denomination (a concept indicating a country (including a region) or currency and an amount of the banknote). The type of a banknote further includes a concept indicating a country (including a region) or currency of the banknote, such as U.S. dollars, Euros, Japanese yen, or Hong Kong dollars regardless of the amount of the banknote.

The orientation of a banknote may be four orientations indicating face-up and portrait-up, face-up and portrait-down, face-down and portrait-up, and face-down and portrait-down, respectively.

The recognition unit 23 recognizes the banknote BN to be recognized, based on the estimated value of the feature amount related to the fluorescent ink, the estimated value being calculated by the estimated value calculation unit 22.

The recognition unit 23 may compare the estimated value of the feature amount output from the estimated value calculation unit 22 with predetermined reference data (for example, a threshold) to recognize the banknote BN to be recognized, for example, determine the authenticity, or the presence or absence of the fluorescent ink. The recognition unit 23 may determine or sort an ink such as the fluorescent ink printed on the banknote BN to be recognized, based on the comparison result. The recognition unit 23 may then recognize the banknote BN, for example, determine the authenticity or the presence or absence of the fluorescent ink, based on the determined or sorted result.

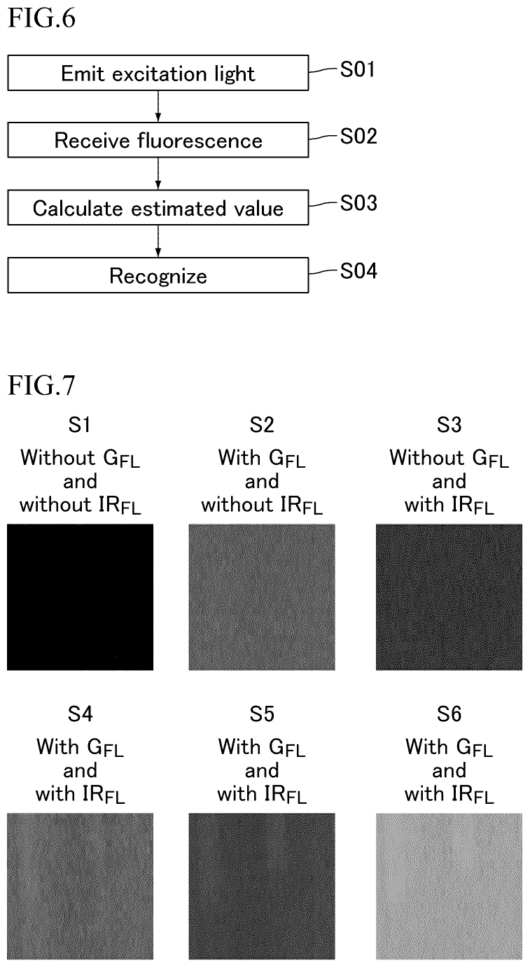

An operation of the sheet recognition unit 1 according to the present embodiment will be described below with reference to FIG. 6.

Before a series of the recognition processing described later, a coefficient is calculated as a least squares solution with the minimum error based on the reference data acquired by emitting the excitation light to the reference medium and the feature amount related to the fluorescent ink associated with the reference data, and is stored in the storage unit 21.

In the recognition processing of the banknote BN to be recognized, as illustrated in FIG. 6, first, the light source 11 emits at least excitation light to the banknote BN to be recognized (step S01).

The light receiving unit 13 including the plurality of light receiving elements receives light emitted from the banknote BN to be recognized, the banknote being irradiated with the excitation light, and outputs a fluorescence detection signal (step S02). The estimated value calculation unit 22 generates detection data in the same format as the reference data based on the fluorescence detection signal.

The estimated value calculation unit 22 then calculates the estimated value of the feature amount related to the fluorescent ink in the banknote BN to be recognized, using the generated detection data and the coefficient stored in the storage unit 21 (step S03).

Thereafter, the recognition unit 23 recognizes the banknote BN to be recognized, based on the calculated estimated value of the feature amount related to the fluorescent ink (step S04), and the operation of the sheet recognition unit 1 ends.

Note that the estimated value calculation unit 22 and the recognition unit 23 may be operated by a control unit (processing circuitry), described later, executing an appropriate program.

The coefficient was actually calculated and the estimated value of the feature amount related to the fluorescent ink in the banknote to be recognized was calculated based on the calculated coefficient. This verification test will be described here.

Samples S1 to S6 in which six types of inks were printed on white paper were used. FIG. 7 illustrates color images captured by emitting ultraviolet light to the samples S1 to S6. Although the images in FIG. 7 are illustrated in gray scale, color images were used in the actual verification test. The ink of the sample S1 is not a fluorescent ink, and does not emit fluorescence in the visible range and the infrared range. The ink of the sample S2 is a fluorescent ink that has an emission peak in the green wavelength band in the visible range but does not emit fluorescence in the infrared range. The ink of the sample S3 is a fluorescent ink that has an emission peak in the near-infrared range but does not emit fluorescence in the visible range. The samples S4 to S6 are special fluorescent inks having an emission peak in the green wavelength band in the visible range and an emission peak in the near-infrared range (however, the samples S4 to S6 have different peak intensity of the emission peaks). That is, the color images of the samples S2 to S6 are color fluorescent images.

First, representative values of the color images of the four samples S1 to S4 (specifically, average values of RGB values) were acquired as reference data, and RGB values Rₘ, Gₘ, and Bₘ (m is an integer of 1 to 4) were acquired for the sample S1 to S4.

Next, the presence or absence (feature (1), GEL) of a pigment emitting fluorescence in the green wavelength band and the presence or absence (feature (2), IR_{FL}) of a pigment emitting fluorescence in the infrared range were acquired as the feature amounts regarding the fluorescent ink of the sample S1 to S4. That is, the sample S1 does not have the features (1) and (2), the sample S2 has the feature (1) and does not have the feature (2), the sample S3 does not have the feature (1) and has the feature (2), and the sample S4 has the features (1) and (2). Here, the case where a pigment was present was indicated by 1, and the case where no pigment was present was indicated by 0.

Next, the reference data of the samples S1 to S4 is associated with the feature amounts related to the fluorescent inks of the samples S1 to S4. Specifically, as illustrated in FIG. 4, in the matrix A and the matrix B, elements in the same row have reference data and feature amounts derived from one sample. That is, the RGB values R₁, G₁, and B₁ of the sample S1 were set in the first row of the matrix A, and the feature amounts (b_{1G}=0, b_{1IR}=0) of the sample S1 were set in the first row of the matrix B. The similar setting was performed for the second and subsequent rows of the matrix A and the second and subsequent rows of the matrix B. However, since the four samples S1 to S4 are used here, both the matrices A and B have four rows.

Coefficients for estimating the feature amounts were calculated as least squares solutions with which an error is minimum, based on the associated reference data and feature amounts. Specifically, as illustrated in FIG. 4, the least squares solutions of AX=B were calculated as the estimated values X\hat{ } of X, and were used as coefficients X_{RG}, X_{GG}, X_{BG}, X_{RIR}, X_{GIR}, and X_{BIR} for estimating the feature amounts.

Representative values of the color images of the six samples S1 to S6 (specifically, average values of RGB values) were acquired as detection data, and RGB values Rn, Gn, and Bn (n is an integer of 1 to 6) were acquired for the sample S1 to S6. Note that the samples S1 to S4 for which the detection data has been acquired are of the same type as the samples S1 to S4 for which the reference data has been acquired, but color images thereof are different from each other.

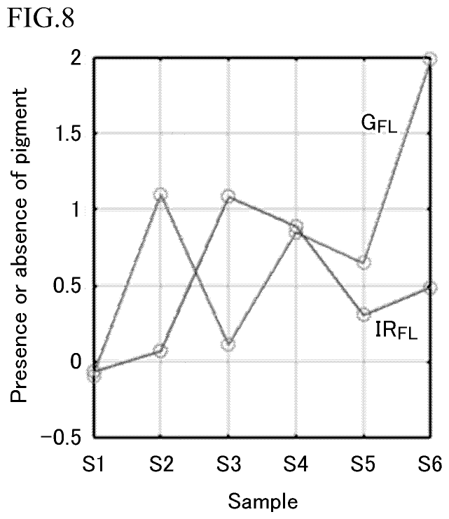

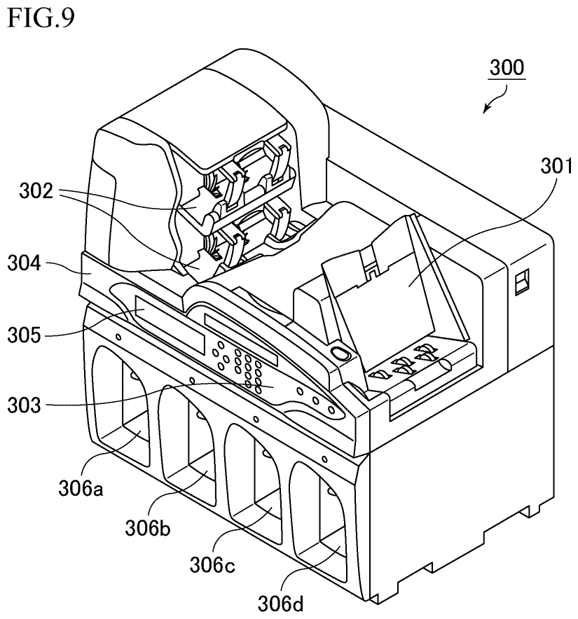

As expressed in the Formulas (1) and (2) of FIG. 5, the estimated values of the feature amounts regarding the fluorescent ink were calculated by performing C·X\hat{ } where C represents the detection data and X\hat{ } represents the coefficient. The calculated estimated values of the feature amounts of the samples are illustrated in FIG. 8. As a result, as for the samples S1 to S4, the presence or absence (feature (1), G_{FL}) of a pigment emitting fluorescence in the green wavelength band and the presence or absence (feature (2), IR_{FL}) of a pigment emitting fluorescence in the infrared range can be accurately estimated. Further, the features (1) and (2) could be similarly estimated for samples S5 and S6 that were not used for coefficient calculation. Note that the samples S5 and S6 were different from the sample S4 in the peak intensity in the respective wavelength bands, but they had results substantially reflecting the intensity ratio.

### Second Embodiment

A sheet handling device according to the present embodiment may have, for example, a configuration illustrated in FIG. 9. A sheet handling device 300 illustrated in FIG. 9 is a small sheet handling device installed and used on a table. This device includes a sheet recognition unit (not illustrated in FIG. 9), a hopper 301, two rejection units 302, an operation unit 303, four stacking units 306a to 306d, and a display unit 305. The sheet recognition unit executes banknote recognition processing. On the hopper 301, a plurality of banknotes to be handled is placed in a stacked state. The rejection units 302 reject a rejection banknote when the banknote fed from the hopper 301 into a housing 304 is a rejection banknote, such as a counterfeit note or a suspect note. The operation unit 303 is for inputting an instruction from an operator. The stacking units 306a to 306d are for sorting and stacking banknotes whose denominations, authenticity, and fitness have been recognized in the housing 304. The display unit 305 is for displaying information such as recognition and count results of banknotes and the stacking statuses of the stacking units 306a to 306d. Among the four stacking units 306a to 306d, fit notes are stored in the stacking units 306a to 306c, and soiled notes are stored in the stacking unit 306d based on the result of the fitness determination by the sheet recognition unit. A method for distributing banknotes into the stacking units 306a to 306d can be optionally set.

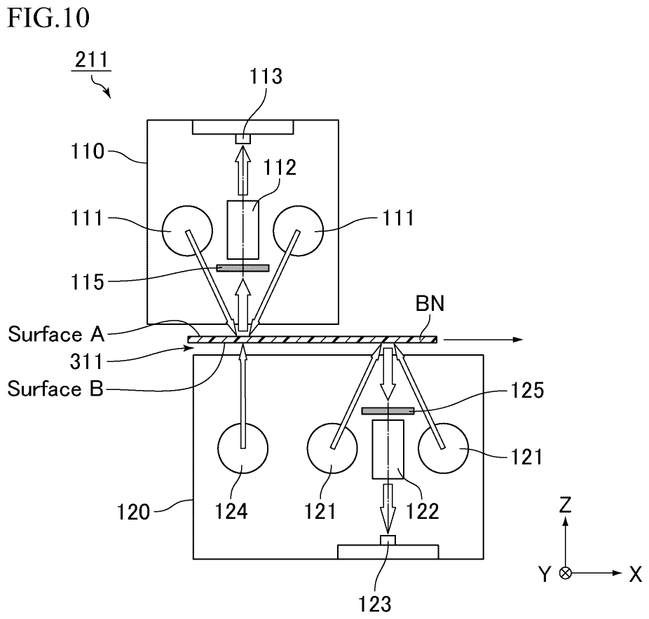

A configuration of an imaging unit that is a main unit of the sheet recognition unit according to the present embodiment will be described below with reference to FIG. 10. As illustrated in FIG. 10, an imaging unit 211 includes an upper unit 110 and a lower unit 120 disposed to face each other. A gap through which a banknote BN is transported in an X direction in an XY plane is formed between the upper unit 110 and the lower unit 120 separated from each other in a Z direction. This gap constitutes a part of a transport path 311 of the sheet handling device according to the present embodiment. The upper unit 110 and the lower unit 120 are positioned on the upper side (+Z direction) and the lower side (−Z direction) of the transport path 311, respectively. The Y direction corresponds to a main scanning direction of the imaging unit 211, and the X direction corresponds to a sub-scanning direction of the imaging unit 211.

As illustrated in FIG. 10, the upper unit 110 includes two light sources 111 for reflection, a condensing lens 112, a light receiving unit (light sensor) 113, and an UV-cutting film 115. The light source 111 for reflection sequentially irradiates a main surface (hereinafter, surface A) of the banknote BN on the light receiving unit 113 side with irradiation light, specifically, infrared light, white light including red light, green light, and blue light, and ultraviolet light as excitation light for fluorescence having different wavelength bands. The condensing lens 112 condenses light emitted from the light source 111 for reflection and reflected from the surface A of the banknote BN, light emitted from a light source 124 for transmission disposed in the lower unit 120 and transmitted through the banknote BN, and fluorescence emitted on the surface A of the banknote BN. The light receiving unit 113 receives the light condensed by the condensing lens 112 and converts the light into an electric signal. After the electric signal is amplified, the electric signal is A-D converted into digital data and then the digital data is output. Here, the light received by the light receiving unit is also referred to as incident light, and the light emitted from the light source is also referred to as irradiation light. The UV-cutting film 115 prevents ultraviolet light emitted from the light source 111 for reflection and reflected by the surface A of the banknote BN from being received by the light receiving unit 113 via the condensing lens 112.

The lower unit 120 includes two light sources 121 for reflection, one light source 124 for transmission, a condensing lens 122, a light receiving unit (light sensor) 123 and a UV-cutting film 125. The light source 121 for reflection sequentially irradiates a main surface (hereinafter, surface B) of the banknote BN on the light receiving unit 123 side with irradiation light having different wavelength bands, specifically, infrared light, white light including red light, green light, and blue light, and ultraviolet light as excitation light for fluorescence. The condensing lens 122 condenses light emitted from the light source 121 for reflection and reflected from the surface B of the banknote BN, and the fluorescence emitted on the surface B of the banknote BN. The light receiving unit 123 receives the light condensed by the condensing lens 122 and converts the light into an electric signal. After the electric signal is amplified, the electric signal is A-D converted into digital data and then the digital data is output. The UV-cutting film 125 prevents ultraviolet light emitted from the light source 121 for reflection and reflected by the surface B of the banknote BN from being received by the light receiving unit 123 via the condensing lens 122.

The light source 124 for transmission is disposed on an optical axis of the condensing lens 112 of the upper unit 110. The light emitted from the light source 124 for transmission is partially transmitted through the banknote BN, is condensed by the condensing lens 112 of the upper unit 110, and is detected by the light receiving unit 113. The light source 124 for transmission may sequentially or simultaneously irradiate the surface B of the banknote BN with irradiation light having different wavelength bands.

In this specification, light having different wavelength bands (irradiation light, incident light, etc.) is, for example, light having different colors as visible light, and is light having wavelength bands partially overlapping or light having non-overlapping wavelength bands as infrared light and ultraviolet light.

Each of the light sources 111, 121, and 124 includes a linear light guide (not illustrated) extending in a direction (main scanning direction D1) perpendicular to the sheet surface of FIG. 10, and a plurality of light-emitting diode (LED) elements (not illustrated) disposed at both ends (or one end) of the light guide.

Each of the light sources 111 and 121 may include an LED element that emits infrared light having a peak wavelength of 750 nm or more, an LED element that emits red light (R) having a peak wavelength of 600 nm or more and less than 750 nm, an LED element that emits green light (G) having a peak wavelength of 500 nm or more and less than 600 nm, an LED element that emits blue light (B) having a peak wavelength of 400 nm or more and less than 500 nm, and an LED element that emits ultraviolet light (UV) having a peak wavelength of less than 400 nm. One light source 111 is disposed on each of the upstream side and downstream side in the transport direction with the condensing lens 112 being interposed therebetween. One light source 121 is disposed on each of the upstream side and downstream side in the transport direction with the condensing lens 122 being interposed therebetween.

The light source 124 may include a plurality of LED elements that emit light having peak wavelengths different from each other. Note that the peak wavelength means a wavelength at which light emission intensity is maximum.

As illustrated in FIG. 2, each of the light receiving units 113 and 123 includes a plurality of pixels 30 arranged in a line in the main scanning direction D1 (direction orthogonal to the transport direction of the banknote BN, i.e. the Y direction). Each pixel 30 includes one first light receiving element (imaging element) 31B having a color filter 32B, one second light receiving element (imaging element) 31G having a color filter 32G, and one third light receiving element (imaging element) 31R having a color filter 32R. Further, the first light receiving element 31B, the second light receiving element 31G, and the third light receiving element 31R are disposed in a line along the main scanning direction D1 in this order.

Each of the upper unit 110 and the lower unit 120 repeatedly images the banknote BN transported in the transport direction and outputs a signal that depends on a light receiving amount. As a result, the imaging unit 211 acquires an image of the entire banknote BN. Specifically, the imaging unit 211 acquires a transmissive image of the banknote BN and a reflective image of the surface A based on the output signal from the upper unit 110, and acquires a reflective image of the surface B of the banknote BN based on the output signal from the lower unit 120.

The imaging unit 211 further acquires a fluorescence detection signal for the entire banknote BN on each of the surface A and the surface B of the banknote BN. That is, the imaging unit 211 can acquire the fluorescent images of the surface A and the surface B of the banknote BN.

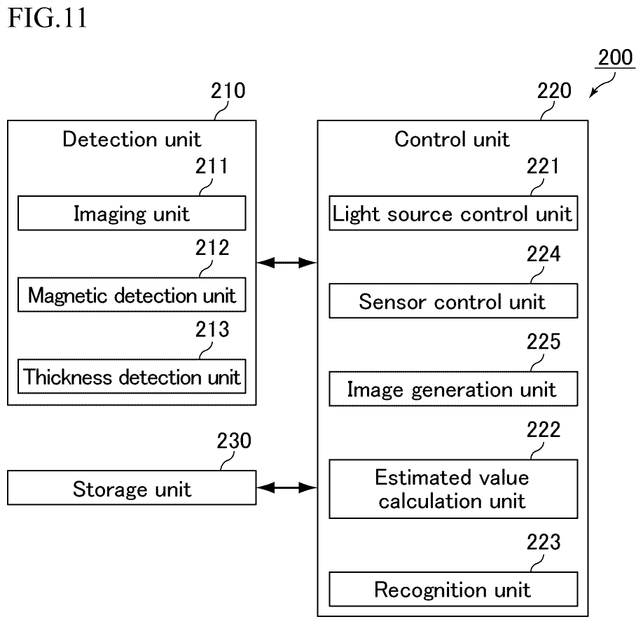

A configuration of the sheet recognition unit according to the present embodiment will be described below with reference to FIG. 11. As illustrated in FIG. 11, a sheet recognition unit 200 according to the present embodiment includes a detection unit 210, a control unit 220, and a storage unit (memory) 230.

The control unit 220 is processing circuitry (processor) that controls respective units of the sheet recognition unit 200. The control unit 220 stores a program for implementing various types of processing. The control unit 220 executes the program. The control unit 220 may include various types of hardware (for example, a field programmable gate array (FPGA)). The control unit 220 controls respective units of the sheet recognition unit 200 based on signals output from the respective units of the sheet recognition unit 200 and control signals from the control unit 220 in accordance with the program stored in the storage unit 230. The control unit 220 further executes functions as a light source control unit 221, a sensor control unit 224, an image generation unit 225, an estimated value calculation unit 222, and a recognition unit 223 in accordance with a program stored in the storage unit 230.

The detection unit 210 includes a magnetic detection unit 212 and a thickness detection unit 213 in addition to the above-described imaging unit 211 along the transport path of a banknote. The imaging unit 211 images a banknote and outputs an image signal (image data) as described above. The magnetic detection unit 212 includes a magnetic sensor (not illustrated) that measures magnetism. The magnetic sensor detects magnetism of magnetic ink, a security thread, etc. printed on a banknote. The magnetic sensor is a magnetic line sensor in which a plurality of magnetic detection elements is arranged in a line. The thickness detection unit 213 includes a thickness detection sensor (not illustrated) that measures a thickness of a banknote. The thickness detection sensor detects tape, multi feed, etc., As for the thickness detection sensor, a sensor disposed at each roller detects a displacement amount during passing of a banknote at rollers facing each other with the transport path interposed therebetween.

The storage unit 230 includes a nonvolatile storage device such as a semiconductor memory or a hard disk, and stores various programs and various data for controlling the sheet recognition unit 200. The storage unit 230 stores coefficients used for estimated value calculation processing executed by the estimated value calculation unit 222. The coefficients are obtained in the same manner as in the first embodiment. The storage unit 230 further stores, as imaging parameters, a wavelength band of irradiation light emitted from each of the light sources 111, 121, and 124 during one cycle of imaging by the imaging unit 211, a timing of turning on and off each of the light sources 111, 121, and 124, a value of a forward current flowing through the LED elements of each of the light sources 111, 121, and 124, a timing of reading a signal from each of the upper unit 110 and the lower unit 120, and the like.

Note that the imaging in one cycle refers to an imaging pattern in which the wavelength band of the irradiation light emitted from each of the light sources 111, 121, and 124, and the timing of turning on and off each of the light sources 111, 121, and 124, and signal reading are set. An image of the entire banknote is acquired by continuously and repeatedly executing the imaging in one cycle as one period.

The light source control unit 221 makes dynamic lighting control of each of the light sources 111, 121, and 124 in order to capture an individual image of a banknote obtained using each of the light sources 111, 121, and 124. Specifically, the light source control unit 221 controls turning-on and turning-off of the light sources 111, 121, and 124 based on the timing set as the imaging parameter. This control is made using a mechanical clock that changes depending on the transport speed of a banknote and a system clock that is always output at a constant frequency regardless of the transport speed of a banknote.

The sensor control unit 224 controls a timing of reading a signal from each of the upper unit 110 and the lower unit 120 based on the timing set as the imaging parameter, and reads a signal from each of the upper unit 110 and the lower unit 120 in synchronization with the timing of turning on and off the light sources 111, 121, and 124. This control is performed using the mechanical clock and the system clock. The sensor control unit 224 then sequentially stores the read signals, that is, the line data in a ring buffer (line memory) of the storage unit 230.

The line data means data based on a signal obtained by each of the upper unit 110 and the lower unit 120 performing one imaging, and corresponds to data for one row in a horizontal direction (direction orthogonal to the transport direction of a banknote, i.e., the Y direction) of the acquired image.

The image generation unit 225 has a function of generating an image based on various signals related to a banknote acquired from the detection unit 210. Specifically, the image generation unit 225 first decomposes the data (image signal) stored in the ring buffer into data for each condition of light irradiation and light reception. The image generation unit 225 then executes correction processing for cutting a dark output, adjusting gain, and correcting a bright output level in accordance with the characteristic of each piece of decomposed data, generates various types of image data of the banknote, and stores the image data in the storage unit 230.

The estimated value calculation unit 222 calculates the estimated value of the feature amount related to the fluorescent ink in the banknote BN to be recognized, using detection data acquired from the banknote BN to be recognized and the coefficients stored in the storage unit 230.

More specifically, the estimated value calculation unit 222 cuts out a region where a fluorescent ink to be recognized is imaged from a color fluorescent image of the entire banknote BN, the color fluorescent image being created by the image generation unit 225, and acquires representative values (for example, an average value for each of the RGB values) calculated from the cut-out image as detection data. The coefficients are acquired from the storage unit 230. The cut-out region and the coefficients may be set appropriately for the type of a banknote. The estimated value calculation unit 222 calculates the estimated value of the feature amount related to the fluorescent ink in the banknote BN to be recognized by calculating a product of the acquired detection data and the coefficients.

The recognition unit 223 recognizes the banknote BN to be recognized, based on the estimated value of the feature amount related to the fluorescent ink, the estimated value being calculated by the estimated value calculation unit 222.

Here, a method for calculating a coefficient and a method for calculating an estimated value of a feature amount will be described more specifically.

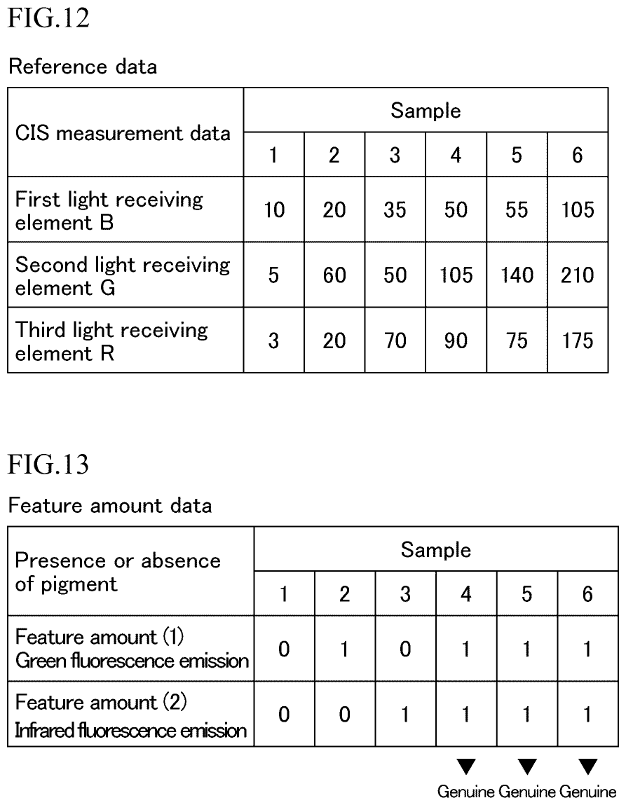

First, excitation light (ultraviolet light) having a specific wavelength is emitted to a banknote sample group as reference media from a light source. Light emitted from each banknote sample is received by a contact image sensor (CIS) to obtain reference data (sensor output values of red (R), green (G), and blue (B)) (see FIG. 12).

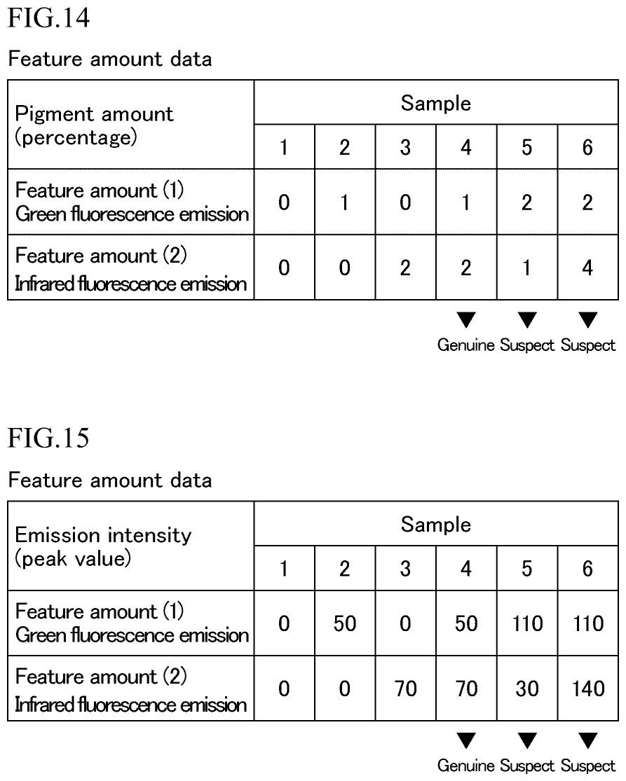

The reference data is associated with feature amounts (see FIGS. 13 to 15) regarding the fluorescent ink to be recognized. FIG. 13 illustrates a case where the first feature amount (1) is a value (present: 1, absent: 0) indicating the presence or absence of a pigment having an emission peak in the green wavelength band, and the second feature amount (2) is a value (present: 1, absent: 0) indicating the presence or absence of a pigment having an emission peak in the infrared range. FIG. 14 illustrates a case where the first feature amount (1) is the content (or percentage) of a pigment having an emission peak in the green wavelength band, and the second feature amount (2) is the content (or percentage) of a pigment having an emission peak in the infrared range. FIG. 15 illustrates a case where the first feature amount (1) is peak intensity in the green wavelength band of the fluorescence emitted from a banknote sample and the second feature amount (2) is peak intensity in the infrared range of the fluorescence emitted from the banknote sample.

For example, when the presence or absence of the pigment illustrated in FIG. 13 is used, in the banknote sample 3, B: 35, G: 50, and R: 70, which are the detection data, are associated with the feature (1): absent (0) and the feature (2): present (1).

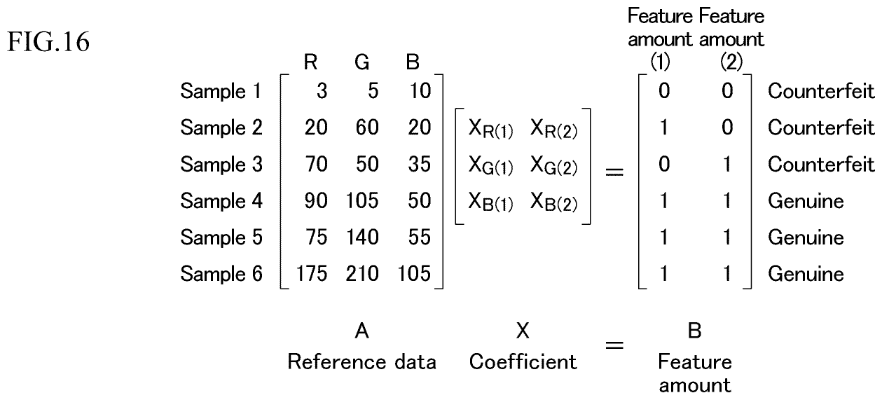

As illustrated in FIG. 16, coefficients for estimating the feature amounts are calculated and stored as least squares solutions with which an error is minimum, based on the associated reference data and feature amounts. Specifically, the coefficients X_{R(1)}, X_{G(1)}, X_{B(1)}, X_{R(2)}, X_{G(2)}, and X_{B(2)} are calculated.

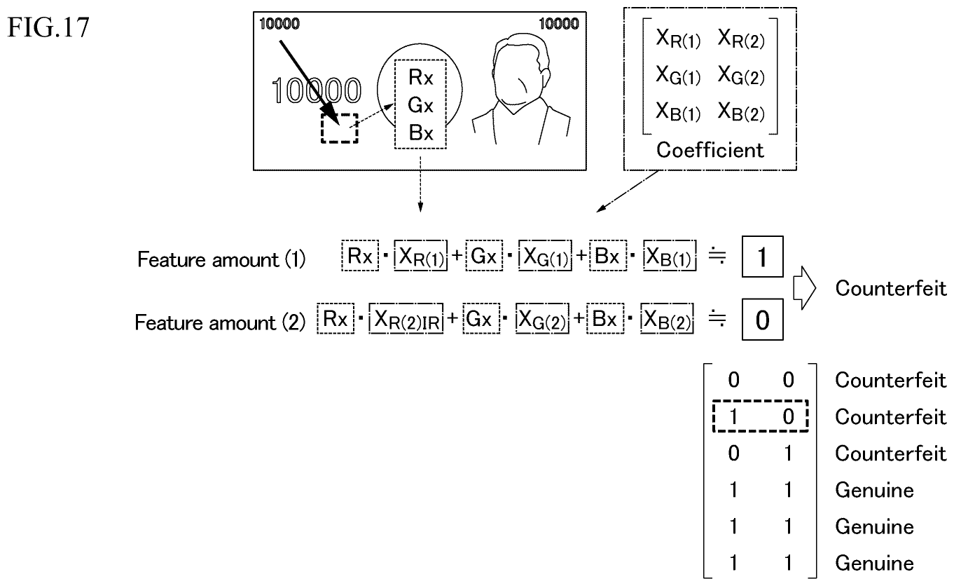

As illustrated in FIG. 17, excitation light (ultraviolet light) having a specific wavelength is emitted to the banknote BN to be recognized from the light source, and the detection data acquired by the light receiving unit 113 or 123 receiving the light emitted from the irradiated banknote BN is subjected to the estimated value calculation processing using the coefficient. Thus, the estimated value of the feature amount related to the fluorescent ink in the banknote BN to be recognized is calculated. Specifically, as illustrated in FIG. 17, products of the RGB values (average values or median values of the respective RGB values) Rₓ, Gₓ, and Bₓ of the light receiving unit during the emission of the excitation light to the banknote BN to be recognized and the coefficients X_{R(1)}, X_{G(1)}, X_{B(1)}, X_{R(2)}, X_{G(2)}, and X_{B(2)} are calculated. As a result, the estimated values of the feature amounts (1) and (2) related to the fluorescent ink in the banknote BN to be recognized are calculated.

The banknote BN to be recognized is recognized, for example, the authenticity, or the presence or absence of the fluorescent ink is determined by comparing the calculated estimated values of the feature amounts (1) and (2) with predetermined reference data (for example, a threshold). For example, in the case of determining a fluorescent ink as a genuine fluorescent ink if both the feature amounts (1) and (2) indicating the presence or absence of a pigment indicate 1, the authenticity of the fluorescent ink can be determined by executing threshold value processing on the calculated estimated values of the feature amounts (1) and (2) (see FIG. 17).

As illustrated in FIGS. 14 and 15, the content or percentage of a pigment and the light intensity are used as the feature amount, and the calculated estimated values of the feature amounts (1) and (2) are not substantially 0 but are different (not approximate) from the feature amounts (1) and (2) of a genuine fluorescent ink. In this case, the banknote may be determined as a suspect note (see the samples 5 and 6 in FIGS. 14 and 15).

### First Modification

The above embodiments have described the case where the RGB values (RGB three-wavelength data) are used as the reference data and the detection data, and the columns of the reference data and the detection data are three-dimensional. However, the number of dimensions (type of data) of the columns of the reference data and the detection data can be set appropriately in accordance with the sensor configuration of the light receiving unit, and may be, for example, four or more. Specifically, for example, an output value in the infrared range (or the near-infrared range) or an output value in all the wavelength bands may be used. More specifically, for example, RGB value+IR value (RGBIR four-wavelength data) may be used by adding a light receiving element that selectively receives only infrared light (or near-infrared light) to the light receiving unit. An RGB value+output values of all the wavelength bands (RGB three-wavelength data and data of all wavelength bands) may be used by adding a light receiving element that receives visible light and infrared light to the light receiving unit. In these cases, the columns of the reference data and the detection data are four-dimensional.

### Second Modification

The above embodiments have described the case where the column of data representing the feature amount is two-dimensional using the feature amount related to the fluorescence emission in the two wavelength bands. However, the number of dimensions (type of data) of the columns of data representing the feature amount can be appropriately set in accordance with the characteristics of a fluorescent ink, and may be three or more, for example. Specifically, for example, the feature amount of the fluorescent ink may be fluorescence emission in three or more wavelength bands. More specifically, the feature amount may be, for example, the presence or absence of three kinds of pigments having emission peaks in the three wavelength bands or the peak intensity of fluorescence emission in each of the three wavelength bands.

### Third Modification

The above embodiments have described the case where the size of the coefficient X (X\hat{ }) is 3 rows and 2 columns. However, as described in the second and third modifications, the size of the coefficient X (X\hat{ }) can be appropriately set depending on the number of dimensions of columns of the reference data and the detection data and the number of dimensions of columns of data representing the feature amount. Specifically, for example, when the columns of the reference data and the detection data are four-dimensional and the number of dimensions of the columns of the data representing the feature amount is three-dimensional, the size of the coefficient X (X\hat{ }) is 4 rows and 3 columns. That is, the size of the coefficient X (X\hat{ }) is usually (the number of dimensions of the columns of the reference data and the detection data) row x (the number of dimensions of the columns of the data representing the feature amount) column.

### Fourth Modification

In the above embodiments, the case where fluorescence is detected as photoluminescence has been described, but phosphorescence (photoluminescence that can be detected after excitation light is turned off) may be used. In this case, a light receiving unit receives phosphorescence emitted from a banknote to be recognized after ultraviolet light as excitation light is turned off. A phosphorescence detection signal is then output. Similarly to the fluorescence detection signal, the recognition processing can be executed using the phosphorescence detection signal. For example, the estimated value of the feature amount related to the phosphorescent ink printed on the banknote to be recognized can be calculated based on the detection data acquired from the phosphorescence detection signal output from the light receiving unit and a coefficient acquired in advance. This makes it possible to authenticate various phosphorescent inks that emit phosphorescence in a predetermined wavelength band after emission of ultraviolet light as excitation light. For example, a special phosphorescent ink having peaks in the visible range and the infrared range can be discriminated. Similarly to the special fluorescent ink, the special phosphorescent ink can also function as a security element with high security because a phosphorescent component that emits light in the infrared region cannot be visually recognized by human eyes.

Although the embodiments have been described above with reference to the drawings, the present disclosure is not limited to the above embodiments. The configurations of the respective embodiments may be appropriately combined or modified without departing from the gist of the present disclosure.

As described above, the present disclosure is a technique useful for discriminating various photoluminescent inks.

What is claimed is:

1. A sheet recognition unit that recognizes a sheet on which a photoluminescent ink is printed, the sheet recognition unit comprising:
a light source capable of emitting at least excitation light;
a light sensor including a plurality of light receiving elements;
a memory that stores a coefficient based on reference data acquired by emitting the excitation light to a reference medium and a feature amount related to the photoluminescent ink associated with the reference data, the coefficient being calculated as a least squares solution with which an error is minimum; and
processing circuitry that calculates an estimated value of the feature amount in a sheet to be recognized, using detection data acquired by the light sensor receiving light emitted from the sheet to be recognized, the sheet being irradiated with the excitation light from the light source, and the coefficient.

2. The sheet recognition unit according to claim 1,
wherein the feature amount is based on at least one of presence or absence of a pigment, a content of the pigment, or a percentage of the pigment in the photoluminescent ink.

3. The sheet recognition unit according to claim 1,
wherein the feature amount is based on intensity of light emitted from the reference medium irradiated with the excitation light.

4. The sheet recognition unit according to claim 1,
wherein a wavelength of the excitation light emitted from the light source is shorter than a wavelength of photoluminescence emitted from the sheet to be recognized and received by the light sensor.

5. The sheet recognition unit according to claim 1,
wherein the excitation light emitted from the light source is ultraviolet light.

6. The sheet recognition unit according to claim 1,
wherein the reference medium emits light in a plurality of wavelength bands when the excitation light is emitted.

7. The sheet recognition unit according to claim 6,
wherein the plurality of wavelength bands includes a visible range and an infrared range.

8. A sheet handling device comprising the sheet recognition unit according to claim 1.

9. A sheet recognition method for recognizing a sheet on which a photoluminescent ink is printed, the sheet recognition method comprising:
a first step of emitting at least excitation light to a sheet to be recognized from a light source;
a second step of receiving, with a light sensor including a plurality of light receiving elements, light emitted from the sheet to be recognized, the sheet being irradiated with the excitation light; and
a third step of calculating an estimated value of a feature amount in the sheet to be recognized, using detection data acquired in the second step and a coefficient based on reference data and the feature amount,
the reference data being data acquired by emitting the excitation light to a reference medium,
the feature amount relating to the photoluminescent ink associated with the reference data,
the coefficient being calculated as a least squares solution with which an error is minimum.

10. A non-transitory computer-readable storage medium storing a sheet recognition program for recognizing a sheet on which a photoluminescent ink is printed, the sheet recognition program causing a sheet recognition unit to execute:
a first processing of emitting at least excitation light to a sheet to be recognized from a light source;
a second processing of receiving, with a light sensor including a plurality of light receiving elements, light emitted from the sheet to be recognized, the sheet being irradiated with the excitation light; and
a third processing of calculating an estimated value of a feature amount in the sheet to be recognized, using detection data acquired in the second processing and a coefficient based on reference data and the feature amount, the reference data being data acquired by emitting the excitation light to a reference medium,
the feature amount relating to the photoluminescent ink associated with the reference data,
the coefficient being calculated as a least squares solution with which an error is minimum.
